(19) United States
(12) Patent Application Publication
(10) Pub. No.: US 2008/0283172 A1
(43) Pub. Date: Nov. 20, 2008

(54) Method for Repairing a Composite Structural Outer Skin

(75) Inventors: Christophe Bernus, Toulouse (FR); Jean-Claude Marty, Grepiac (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Airbus France, Toulouse (FR)

(21) Appl. No.: 12/066,677

(22) PCT Filed: Sep. 27, 2006
(86) PCT No.: PCT/EP2006/066814

§ 371 Date: Mar. 13, 2008

(30) Foreign Application Priority Data
Sep. 29, 2005 (FR) 05/52951

(51) Int. Cl. B29C 73/10

(52) U.S. Cl. 156/98

(57) ABSTRACT

A composite structure including two external skins and an internal core between them, wherein a portion of one of the external skins has to be replaced, with pressure from a counter-form and suction. The repair is accomplished by piercing a vent hole in the opposite external skin to discharge the air in the cells of the core, which improves adhesive bonding of the new portion on the core.

The invention relates to a method for repairing an external skin of a composite structure, comprising an internal cellular core between a pair of external skins, including one which is subject to repair.

Such a composite structure is encountered in a lot of devices, notably transportation, railway, seagoing, or aeronautical machines; for example on ship hulls, or on external streamline shapes, leading edges of wings, aircraft ailerons and radomes.

The skin of the structure which faces the outside is often damaged to a degree which imposes its replacement. A new skin portion is laid by drape moulding on the structure at the location to be repaired and left to harden. In order to guarantee a nice smooth repaired surface, and without any difference in level with the original skin at the edge of the new portion, a counter-form is laid and pressed onto the new skin portion before hardening, in order to bring it in extension with the original skin.

There is a risk of a bonding failure between the new skin portion and the underlying core in spite of this precaution. The object of the invention is to eliminate this risk and to provide quality of the adhesive bonding of the external skin on the core.

The bonding failure may come from the lack of setting up pressure of the core on the skins during the baking which accomplishes the hardening, itself caused by the pressure of the air which is entrapped in the cells of the core and which the pressure of the counter-form prevents from emerging from under the edges of the new skin portion. In the usual methods, the portion to be repaired of the structure is wrapped up in a bag forming a chamber in which a vacuum is applied in order to pump the excesses of resin and drain this air, but draining is not always achieved in a satisfactory way.

In a general embodiment, the invention relates to a method for repairing a composite material structure comprising an internal cellular core between two opposite external skins, consisting of replacing a portion of one of said external skins with a new portion, laying a rigid counter-form on the new portion and around it, pressing the counter-form onto the composite structure and hardening the new portion, characterized in that it comprises, before hardening, a step for piercing the other of said external skins right up to the internal core and for draining the air contained in the internal core. In a more complicated but further general embodiment, the invention relates to a method for repairing a composite material structure comprising an internal cellular core between two opposite external skins, consisting of replacing a portion of one of said external skins with a new portion, laying a rigid counter-form on the new portion and around it, pressing the counter-form on the composite structure and hardening the new portion, characterized in that it comprises, before hardening, a step for piercing the other of said external skins right up to the internal core and for draining the air contained in the internal core, followed, if necessary, by filling up the holes with resin in order to guarantee the seal of the structure.

These aspects of the invention, as well as other ones, will now be described in connection with the following figures:

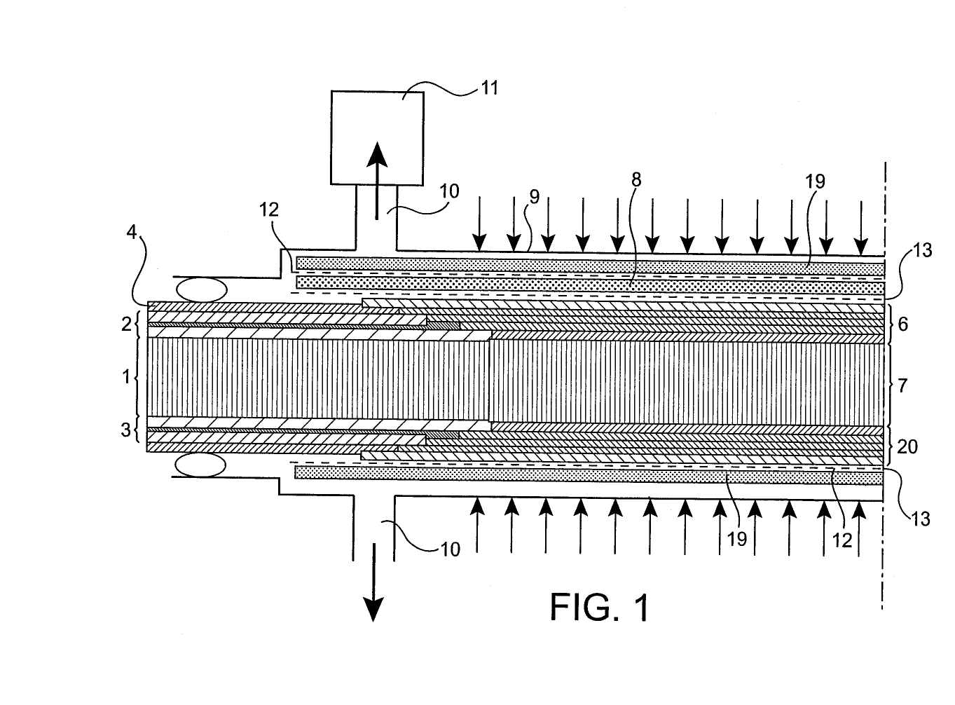

FIG. 1 is a general view of a standard repair method,

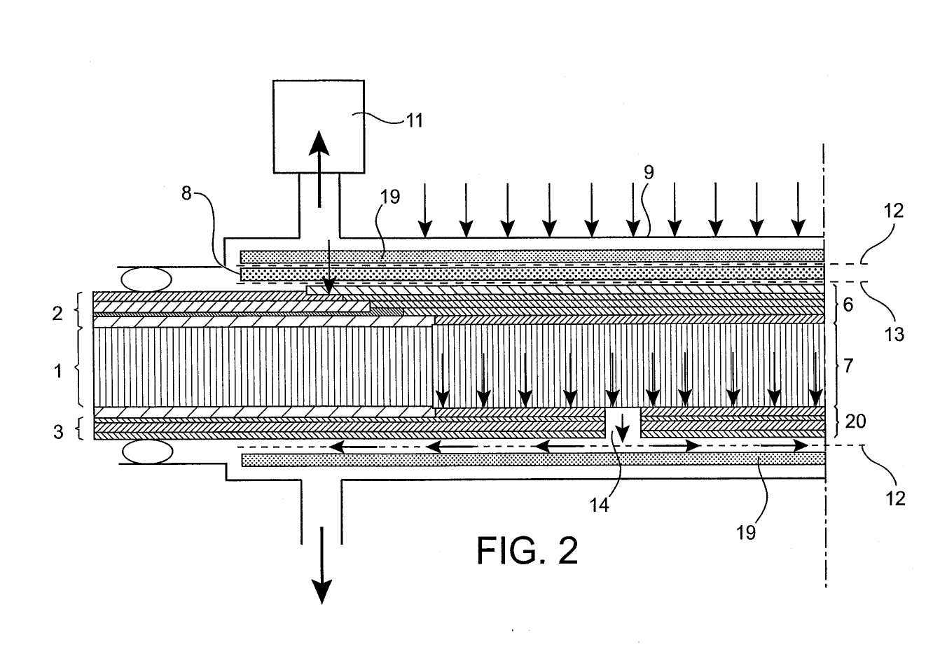

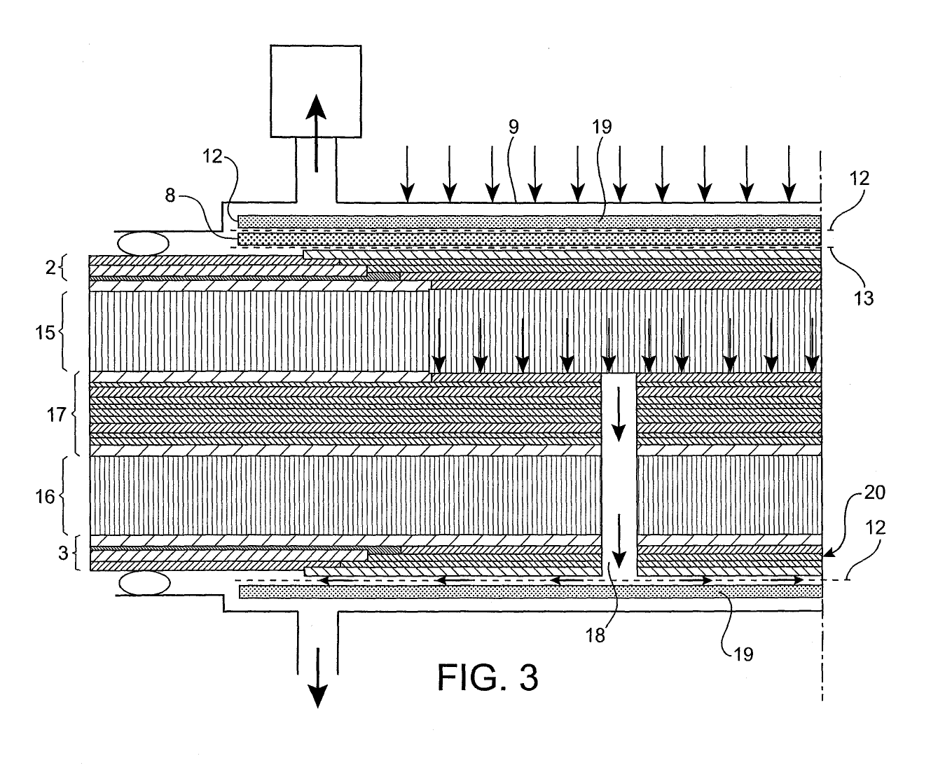

and FIGS. 2 and 3 illustrate two main alternative embodiments of the invention.

The structure of FIG. 1 comprises an internal core 1 and two opposite external skins 2 and 3 between which the core 1 is inserted with adhesive bonding. The external skins 2 and 3 generally consist of folded polymer layers which have been successively drape-molded and then hardened. The internal core 1 is cellular, often consisting of a honeycomb structure, the cells of which 5 extend from one of the external skins 2 to the other one 3. The repair relates to the external skin 2, the damaged portion of which is removed and replaced with a new skin portion 6, the structure of which is identical with that of the external skin 2. Alternatively, an underlying portion of the core 1 may be also removed and replaced with a new core portion 7. Still alternatively, an underlying portion of the other external skin 3 may also be removed and replaced with another new skin portion 20. These alternatives, which above all depend on the depth of the damages, have no influence on the invention, which may be applied in the same way.

Traditional tooling comprises a counter-form 8 usually as a plate which is laid on the new skin portion 6. The lower face of the counter-form 8, pressed onto the new skin portion 6 and, around it, on a border of the original external skin 2, has a shape and surface quality corresponding to those which is intended to be obtained for the external skin 2 after the repair. The counter-form 8 is pressed onto the external skin 2 and compresses the new skin portion 6. This is achieved by confining the portion to be repaired of the structure in a vacuum bag 9, the vents 10 of which on each face of the structure are connected to a vacuum pump 11 or a similar apparatus. Heating carpets 12 are slipped into the vacuum bag 9 in order to bake the resin-impregnated polymer layers of the new skin portion 6. The lower face of the counter-form 8 is often coated with polytetrafluoroethylene (PTFE) in order to provide easy removal of the mold after hardening; a pealable sheet 13 may also be slipped under it, in contact with the new skin portion 6. Finally, environment fabrics 19 are placed between the internal face of the vacuum bag 9 and the heating carpets 12. Draining is carried out through them.

The vacuum pump 11 sucks the air included in the vacuum bag 9, but it is incapable of suitably doing this for the air included in the cells 5 of the internal core 1 under the new skin portion 6 since the pressure of the counter-form 8 prevents it from flowing through underneath the edge of the new skin portion 6 while producing sufficient adherence for the seal with the original portion of the external skin 2. Bonding defects between the internal core 1 and the new skin portion 6 may appear after hardening. This is why, according to the invention and as illustrated in FIG. 2, a vent hole 14 is made through the other external skin 3, under the new skin portion 6, which produces effective draining of the cells below and around the vent 14, directly or through interstices between the internal core 1 and the external skin 3. Adhesive bonding of the new skin portion 6 is guaranteed, as it adheres well to the internal core 1 and the free surface of the external skin 2 has a good and generally better condition than with the prior method, which improves the aspect of the structure and retains its radio-electric transparency while avoiding possible plugging (filling) of the external skin in order to restore its suitable aspect during subsequent painting phases, which represents a major advantage for radomes of aircrafts. Further, repair is fast.

An alternative embodiment will now be described in FIG. 3. This structure may for example relate to radomes of aircraft noses made in the form of a double sandwich for reasons of optimizing transparency at various frequencies. The internal core 1 is replaced with an internal layer consisting of two cores 15 and 16, separated by a middle skin 17 with a constitution similar to that of the external skins 2 and 3. The vent 14 is then replaced with a vent 18 which not only crosses the external skin 3 directed towards the inside of the structure, but also the internal layer of the core 16 facing it and the middle skin 17, until it opens out under the other internal layer of the core 15 which faces the new skin portion. The invention is moreover not modified, the vent 18 operating as the vent 14, the vent 18 also being filled up again. Here also, new portions of other skins or core layers may replace damaged prior portions, as in the first way of proceeding.

1-8. (canceled)

9. A method for repairing a composite material structure including a cellular internal core between two opposite external skins, the method comprising:
replacing a portion of one of the external skins with a new portion;
laying a rigid counter-form on the new portion and around the new portion;
pressing the counter-form onto the composite material structure and hardening the new portion; and
before the hardening, piercing the other of the external skins right up to the internal core and draining the air contained in the internal core.

10. The method for repairing a composite material structure according to claim 9, wherein the internal core is a honeycomb structure with cells extending between two of the skins.

11. The method for repairing a composite material structure according to claim 9, wherein the counter-form includes a surface laid on the new portion, which is in polytetrafluoroethylene.

12. The method for repairing a composite material structure according to claim 9, wherein a pealable sheet is laid between the counter-form and the new portion.

13. The method for repairing a composite material structure according to claim 9, wherein the piercing is again filled up with resin.

14. The method for repairing a composite material structure according to claim 9, further comprising replacing a new portion before laying the counter-form.

15. The method for repairing a composite material structure according to claim 9, further comprising replacing a portion of the internal core with a new portion before laying the counter-form.

16. A method for repairing a composite material structure including a cellular internal core between two opposite external skins, and a middle skin separating the internal core into two layers, the method comprising:
replacing a portion of one of the external skins with a new portion;
laying a rigid counter-form on the new portion and around the new portion;
pressing the counter-form onto the composite structure and hardening the new portion; and
before the hardening, piercing the other of the external skins of one of the layers of the internal core and of the middle skin right up to the other layer of the internal core, and draining the air contained in the internal core.

17. The method for repairing a composite material structure according to claim 16, wherein the internal core is a honeycomb structure with cells extending between two of the skins.

18. The method for repairing a composite material structure according to claim 16, wherein the counter-form includes a surface laid on the new portion, which is in polytetrafluoroethylene.

19. The method for repairing a composite material structure according to claim 16, wherein a pealable sheet is laid between the counter-form and the new portion.

20. The method for repairing a composite material structure according to claim 16, wherein the piercing is again filled up with resin.

21. The method for repairing a composite material structure according to claim 16, further comprising replacing a new portion before laying the counter-form.

22. The method for repairing a composite material structure according to claim 16, further comprising replacing a portion of the internal core with a new portion before laying the counter-form.
